(19) United States
(12) Patent Application Publication
(10) Pub. No.: US 2016/0148245 A1
(43) Pub. Date: May 26, 2016

(54) METHODS AND SYSTEMS FOR CROWDSOURCING TASKS

(71) Applicant: XEROX CORPORATION, Norwalk, CT (US)

(72) Inventors: Laura Elisa Celis, St Sulpice (CH); Chithralekha Balamurugan, Pondicherry (IN)

(21) Appl. No.: 14/554,095

(22) Filed: Nov. 26, 2014

(51) Int. Cl. G06Q 30/02; G06Q 50/00; G06F 17/30

(52) U.S. Cl. CPC G06Q 30/0241; G06F 17/30876; G06Q 30/0207; G06Q 50/01

(57) ABSTRACT

The disclosed embodiments illustrate methods and systems for crowdsourcing a task. The method includes presenting one or more advertisements to a worker along with said task. The one or more advertisements are determined based on at least a type of said task being attempted by said worker, one or more tasks previously attempted by said worker, and a profile of said worker. Thereafter, an incentive to said worker is provided based on said presentation of said one or more advertisements, in addition to providing a remuneration for attempting said task.

### TECHNICAL FIELD

The presently disclosed embodiments are related, in general, to crowdsourcing. More particularly, the presently disclosed embodiments are related to methods and systems for presenting advertisements in crowdsourcing.

### BACKGROUND

Crowdsourcing has emerged as a convenient and an economical method for organizations to outsource certain tasks, which require human involvement. For example, tasks such as digitization of handwritten documents, labeling of images, anomaly detection in videos, and so on, may be uploaded by a requester on one or more crowdsourcing platforms. Further, one or more crowdworkers associated with the one or more crowdsourcing platforms may attempt such tasks.

In addition, the organizations may need a time-bound and a high quality solution for the crowdsourcing tasks posted on the crowdsourcing platform. To make the crowdsourcing of the tasks cost effective and to attract a large number of crowdworkers, the organization may pay (through crowdsourcing platform) a predetermined amount to the crowdworkers for completing the crowdsourced tasks. In an embodiment, the predetermined amount is determined based on budget of the requester. If the requester does not have the budget to remunerate the crowdworker, the crowdworker may not receive expected remuneration completing the tasks. This may demotivate the crowdworkers to attempt such tasks.

### SUMMARY

According to embodiments illustrated herein, there is provided a method for crowdsourcing a task. The method includes presenting one or more advertisements to a worker along with said task. The one or more advertisements can be determined based on a type of said task being attempted by said worker, one or more tasks previously attempted by said worker, a profile of said requester, and a profile of said worker. The method further includes providing an incentive to said worker based on said presentation of said one or more advertisements, in addition to providing a remuneration for attempting said task. The method further includes offering a discount to said requester on a price for crowdsourcing said task. The method further includes receiving said incentive from an advertiser based on said presentation of said one or more advertisements to said worker along with said task. The method is performed by one or more processors.

According to embodiments illustrated herein, there is provided a system for crowdsourcing a task. The system includes one or more processors operable to present one or more advertisements to a worker along with said task. The one or more advertisements can be determined based on a type of said task being attempted by said worker, one or more tasks previously attempted by said worker, a profile of said requester, and a profile of said worker. The one or more processors are further operable to provide an incentive to said worker based on said presentation of said one or more advertisements, in addition to providing a remuneration for attempting said task. The one or more processors are further operable to offer a discount to said requester on a price for crowdsourcing said task. The one or more processors are further operable to receive said incentive from an advertiser based on said presentation of said one or more advertisements to said worker along with said task.

According to embodiments illustrated herein, there is provided a computer program product for use with a computer. The computer program product includes a non-transitory computer readable medium. The non-transitory computer readable medium stores a computer program code for crowdsourcing a task. The computer program code is executable by one or more processors to present one or more advertisements to a worker along with said task. The one or more advertisements can be determined based on a type of said task being attempted by said worker, one or more tasks previously attempted by said worker, a profile of said requester, and a profile of said worker. The computer program code is further executable by the one or more processors to provide an incentive to said worker based on said presentation of said one or more advertisements, in addition to providing a remuneration for attempting said task. The computer program code is further executable by the one or more processors to offer a discount to said requester on a price for crowdsourcing said task. The computer program code is further executable by the one or more processors to receive said incentive from an advertiser based on said presentation of said one or more advertisements to said worker along with said task.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a crowdsourcing platform server, in accordance with at least one embodiment;

FIG. 3 is a flowchart illustrating a method for crowdsourcing a task, in accordance with at least one embodiment; and

FIG. 4 illustrates a block diagram of a crowdworker interface, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

“Crowdsourcing” refers to distributing tasks (hereinafter, also referred to as crowdsourcing tasks) by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms may include, but are not limited to, Amazon Mechanical Turk, Crowd Flower, or Mobile Works.

A “crowdsourcing task” refers to a piece of work, an activity, an action, a job, an instruction, or an assignment to be performed. Crowdsourcing tasks may necessitate the involvement of one or more crowdworkers. Examples of the tasks may include, but are not limited to, image/video/text labelling/tagging/categorization, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image analysis, directory compilation, or information search/retrieval.

A “remuneration” refers to a reward paid to a worker for completing a task posted on a crowdsourcing platform. In an embodiment, the worker may be remunerated with monetary benefits. Other forms of the remuneration may include, but are not limited to, lottery tickets, gift items, shopping vouchers, and discount coupons. In another embodiment, remuneration may further correspond to non-monetary benefits, such as strengthening of the relationship between the worker and the requester. For example, the requester may provide the worker with an access to more tasks so that the worker can gain more. A person skilled in the art would understand that combination of any of the above-mentioned means of remuneration could be used and the task completion cost for the requesters may be inclusive of such remunerations receivable by the corresponding workers.

A “crowdworker” refers to a workforce/worker(s) that may perform one or more tasks that generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be used interchangeably.

A “profile of crowdworker” refers to a set of information pertaining to the one or more crowdworkers. For example, the profile of the crowdworker may include information, such as, but is not limited to, location of the crowdworkers, gender of the crowdworkers, age of the crowdworkers, hobbies of the crowdworkers, marital status of the crowdworker, educational qualification of the crowdworkers, occupation of the crowdworker, income level of the crowdworker, and so forth.

A “profile of requester” refers to a set of information pertaining to the one or more requesters. For example, the profile of the requester may include information, such as, but is not limited to, location of the requesters, hobbies of the requesters, and the type of the tasks posted by the requester.

An “advertisement” refers to information presented to the crowdworker in addition to information pertaining to crowdsourcing tasks. In an embodiment, the advertisements may include text, pictures, logos, symbols, hyperlinks, or a combination thereof that may be utilized for selling/promoting a product/service. In an embodiment, the advertisement may be displayed to the crowdworkers, along with the crowdsourcing tasks, on a display device associated with the crowdworker. In an embodiment, the advertisements may be presented to the crowdworkers in different ways, such as a pop-up advertisement, a voice advertisement, a text/image advertisement adjacent to the crowdsourcing tasks, and the like.

“Incentive” refers to rewards corresponding to the presentation of the one or more advertisements along with the crowdsourcing tasks. In an embodiment, the incentives may be paid to at least one of the crowdworker, the requester, or the crowdsourcing platform, based on the presentation of the one or more advertisements. In an embodiment, the presentation of the one or more advertisements may be allowed/authorized by the crowdworker or the requester. The incentives may be paid in monetary (e.g., cash, gift items, discount coupons, shopping vouchers, lottery tickets) and non-monetary forms (e.g., strengthening of the relationship between the crowdworker and the requester), as disclosed above.

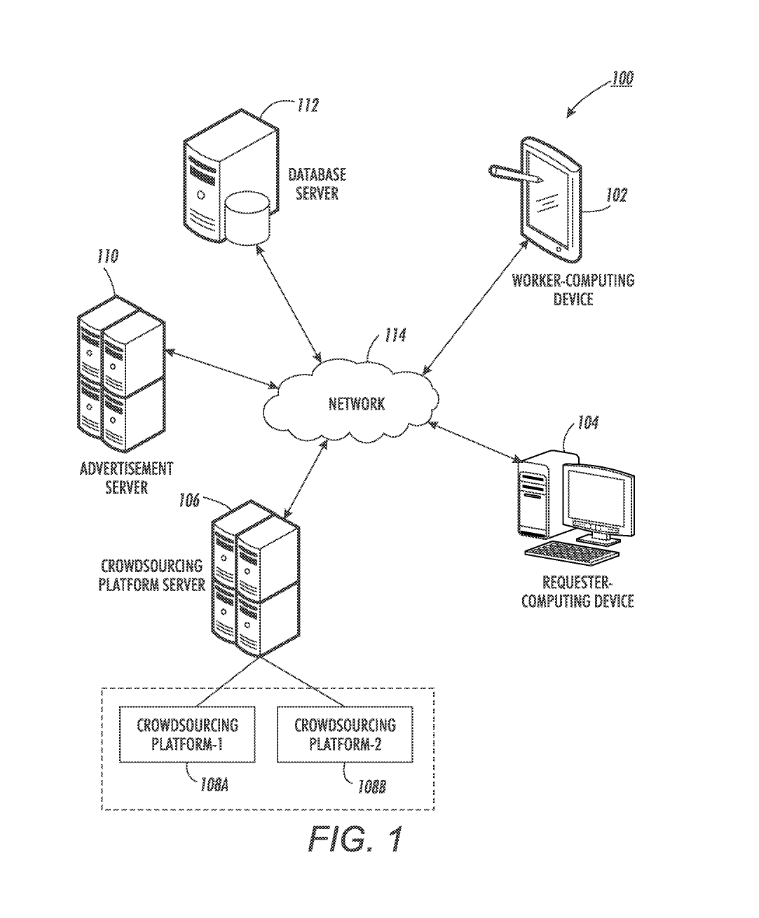

FIG. 1 is a block diagram illustrating a system environment 100 in which various embodiments may be implemented. The system environment 100 includes a worker-computing device 102, a requester-computing device 104, a crowdsourcing platform server 106, an advertisement server 110, a database server 112, and a network 114. Various devices in the system environment 100 (e.g., the worker-computing device 102, the requester-computing device 104, the crowdsourcing platform server 106, the advertisement server 110, and the database server 112) may be interconnected over the network 114.

The worker-computing device 102 refers to a computing device, used by a crowdworker, to perform one or more crowdsourcing tasks. In an embodiment, the crowdworker may receive the one or more crowdsourcing tasks on a display associated with the worker-computing device 102. Subsequently, the crowdworker may submit responses to the one or more crowdsourcing tasks using the worker-computing device 102. The crowdworker may provide responses using one or more input devices (e.g., keyboard, touch-interface, gesture-recognition, etc.) associated with the worker-computing device 102. In an embodiment, the crowdworker may provide an input pertaining to the allowance of the presentation of the one or more advertisements along with the one or more crowdsourcing tasks being attempted by the crowdworker. The worker-computing device 102 may include a variety of computing devices, such as a laptop, a personal digital assistant (PDA), a tablet computer, a smartphone, a phablet, and the like.

The requester-computing device 104 may refer to a computing device, used by the requester, to upload information pertaining to the one or more crowdsourcing tasks on the crowdsourcing platform server 106. In an embodiment, the requester may access the crowdsourcing platform server 106 to upload the information. For example, if the crowdsourcing task corresponds to the digitization of the handwritten content, the requester may provide electronic documents that include handwritten content. In an embodiment, using the requester-computing device 104, the requester may provide information corresponding to the allowance of the presentation of the one or more advertisements along with the crowdsourcing tasks posted by that requester. In such a scenario, the requester may provide information pertaining to the one or more advertisements to be displayed to the crowdworker along with the one or more crowdsourcing tasks. The requester-computing device 104 may include a variety of computing devices, such as a desktop, a computer server, a laptop, a personal digital assistant (PDA), a tablet computer, and the like.

The crowdsourcing platform server 106 may refer to a device or a computer that hosts one or more crowdsourcing platforms (e.g., crowdsourcing platform-1 108a and crowdsourcing platform-2 108b, depicted in the system environment 100). In an embodiment, the crowdsourcing platform server 106 may receive a request from the requester-computing device 104 to crowdsource the task. The request may include information pertaining to the one or more crowdsourcing tasks. In an embodiment, the crowdsourcing platform server 106 may receive information pertaining to the one or more advertisements from the advertisement server 110. Thereafter, the crowdsourcing platform server 106 may communicate the crowdsourcing tasks (received from the requester-computing device 104) to the one or more crowdworkers along with the one or more advertisements (received from the advertisement server 110). For presenting the one or more advertisements to the crowdworker, the crowdsourcing platform server 106 may utilize the profile information associated with the one or more crowdworkers and the one or more requesters. In an embodiment, the crowdsourcing platform server 106 may retrieve profile information from the database server 112. The crowdsourcing platform server 106 may be realized through various types of application servers such as, but not limited to, Java application server, .NET framework, and Base4 application server.

The advertisement server 110 may refer to a device or a computer that maintains a repository of advertisements. The advertisement server 110 may include information pertaining to various attributes of the advertisements, such as location attributes, content attributes, purchase attributes, interest attributes etc. In an embodiment, such attributes associated with the one or more advertisements may be utilized by the crowdsourcing platform server 106 to determine which advertisement should be presented to which crowdworker. In an embodiment, the advertisement server 110 may transmit the one or more advertisements along with the associated attributes to the crowdsourcing platform server 106. The advertisement server 110 may be realized through various technologies such as, but not limited to, Microsoft® SQL server, Java application server, .NET framework, Base4, Oracle, and My SQL.

It will be apparent to a person skilled in the art that the crowdsourcing platform server 106 may also receive the information pertaining to the one or more advertisements from the requester-computing device 104, without departing from the scope of the disclosure.

The database server 112 may refer to a device or a computer that maintains a repository of tasks assigned to the crowdworkers. In an embodiment, the database server 112 may store the profile information associated with the crowdworkers and the requesters. The database server 112 may receive a query from the crowdsourcing platform server 106 to retrieve the profile information associated with the one or more crowdworkers and the one or more requesters. For querying the database server 112, one or more querying languages may be utilized such as, but not limited to, SQL, QUEL, DMX and so forth. Further, the database server 112 may be realized through various technologies such as, but not limited to, Microsoft® SQL server, Oracle, and My SQL. In an embodiment, the crowdsourcing platform server 106 may connect to the database server 112 using one or more protocols such as, but not limited to, ODBC protocol and JDBC protocol.

It will be apparent to a person skilled in the art that the functionalities of the database server 112 may be incorporated into the crowdsourcing platform server 106, without departing from the scope of the disclosure.

The network 114 corresponds to a medium through which content and messages flow between various devices of the system environment 100 (e.g., the worker-computing device 102, the requester-computing device 104, the crowdsourcing platform server 106, the advertisement server 110 and the database server 112). Examples of the network 114 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

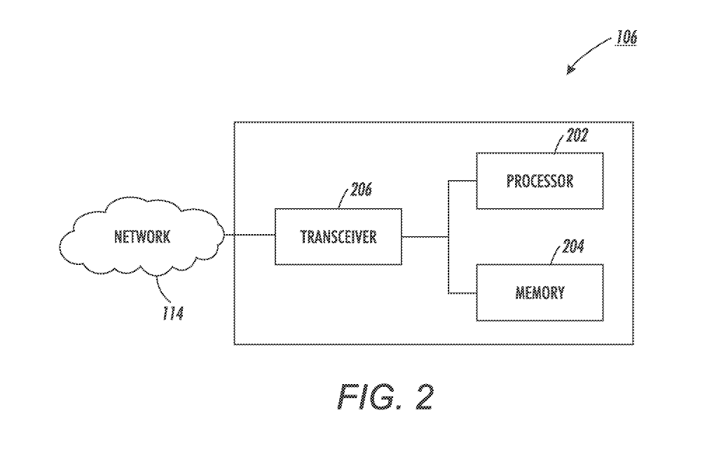

FIG. 2 is a block diagram illustrating the crowdsourcing platform server 106, in accordance with at least one embodiment. The crowdsourcing platform server 106 includes a processor 202, a memory 204, and a transceiver 206.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enables the hardware of the crowdsourcing platform server 106 to perform the predetermined operation.

The transceiver 206 transmits and receives messages and data to/from various components of the system environment 100. Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

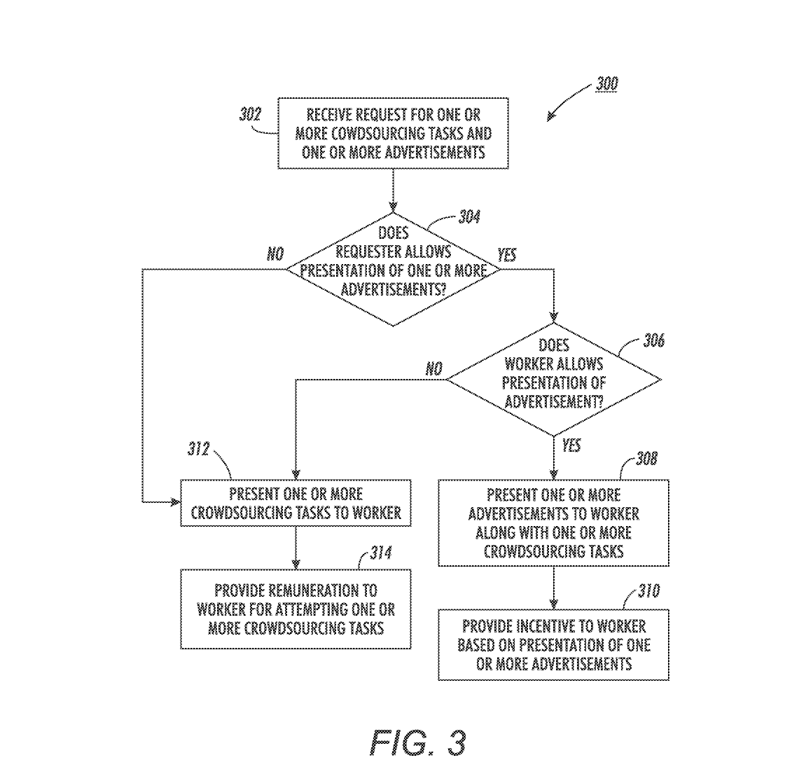

The operation of the crowdsourcing platform server 106 for crowdsourcing a task has been described in conjunction with FIG. 3.

FIG. 3 is a flowchart 300 illustrating a method for crowdsourcing a task, in accordance with at least one embodiment. The flowchart 300 is described in conjunction with FIG. 1 and FIG. 2.

At step 302, a request for one or more crowdsourcing tasks and one or more advertisements is received. In an embodiment, the processor 202 may receive the request. In an embodiment, the processor 202 may receive information pertaining to the one or more crowdsourcing tasks from the requester-computing device 104. Further, the processor 202 may receive the one or more advertisements from the advertisement server 110. As discussed, the one or more advertisements may include texts, pictures, hyperlinks, logos etc. that needs to be displayed to the crowdworker, while the crowdworker attempts the crowdsourcing tasks.

It will be apparent to a person skilled in the art that the processor 202 may also receive the information pertaining to the one or more advertisements from the requester-computing device 104, without departing from the scope of the disclosure. In such a scenario, the requester, who transmits the one or more crowdsourcing tasks, may also transmit additional information (e.g., pictures, symbols, logos, text, and hyperlinks) to be displayed as advertisements.

At step 304, it is determined whether the requester allows the presentation of the one or more advertisements to the crowdworker while the crowdworker attempts the one or more crowdsourcing tasks. The processor 202 may determine this based on the request received from the requester. In an embodiment, the requester may indicate the crowdsourcing platform server 106 whether the requester wishes to display the advertisements to the crowdworker, while the crowdworker attempts the tasks. The database server 112 may store such information about different requesters, and the processor 202 may retrieve such information from the database server 112, as and when required. For example, the database server 112 may maintain a mapping table that may further include the mapping of different requesters against their allowance for the presentation of the one or more advertisements along with the one or more crowdsourcing tasks. Table 1 illustrates one such mapping table:

TABLE 1
Illustration of the mapping table for allowance
of advertisements by different requesters

| | Allows advertisements with |
|---|---|
| Requester | the crowdsourcing tasks |
| Requester - 1 | Yes |
| Requester - 2 | Yes |
| Requester - 3 | No |

It can be observed from Table 1 that requester-1 and requester-2 allows the presentation of the one or more advertisements along with the crowdsourcing tasks posted by them, whereas the requester-3 does not allow the advertisements to be presented along with the crowdsourcing tasks posted by him.

In an embodiment, the motivation for the requesters to allow the presentation of the one or more advertisements along with the crowdsourcing tasks may be to earn discounts while posting the crowdsourcing tasks on the crowdsourcing platform server 106. For example, the crowdsourcing platform server 106 may provide discounts to the requester for posting subsequent crowdsourcing tasks, if the requester allows for the presentation of the advertisements. Table 2 provided below illustrates such a scenario:

TABLE 2
Illustration of discount received by requester
for allowance of advertisements

| | Cost for posting the | Cost for posting the |
|---|---|---|
| | crowdsourcing task | crowdsourcing task |
| Crowdsourcing task | without advertisement | with advertisement |
| Task_1 | 1 cent | 0.8 cent |
| Task_2 | 2 cent | 1.5 cent |

As depicted in Table 2, the crowdsourcing platform server 106 charges a fee of 1 cent from the requester for posting a crowdsourcing task “Task_1” when the requester does not allow the presentation of the advertisement. However, if the requester allows the presentation of the advertisement along with the crowdsourcing tasks, the crowdsourcing platform server 106 offers a discount (and charges a fee of 0.8 cents) for posting the crowdsourcing task “Task_1”. Thus, to earn such discounts, the requester may consider allowing the presentation of the advertisement along with the crowdsourcing tasks.

In a similar way, the motivation for the requesters for not allowing the presentation of the advertisements may be that the requester does not want to distract the crowdworkers while the crowdworkers attempt the crowdsourcing tasks posted by that requester. For example, if the requester posts crowdsourcing tasks related to scientific research, the requester may not want to clutter the crowdworkers' display with advertisement, so as not to distract the crowdworkers while they attempt the tasks. In such a scenario, the requester may not allow the presentation of the advertisements along with the crowdsourcing tasks to the crowdworkers.

If the processor 202 determines that the requester allows the presentation of the one or more advertisements to the crowdworker while the crowdworker attempts the crowdsourcing task, step 306 is performed, else step 312 is performed.

At step 306, it is determined whether the crowdworker allows the presentation of the one or more advertisements along with the one or more crowdsourcing tasks. The processor 202 may determine this based on an input received from the crowdworker. The input is deterministic of the allowance to present the one or more advertisements along with the one or more crowdsourcing tasks. In an embodiment, the database server 112 may maintain the information pertaining to such inputs. For example, the database server 112 may maintain a mapping table that may include the mapping between different crowdworkers and their preferences corresponding to the display of the advertisements when they perform the crowdsourcing tasks. Table 3 provided below illustrates one such mapping table:

TABLE 3
Illustration of the mapping table for allowance
of advertisements by different crowdworkers

| | Allows advertisements with |
|---|---|
| Crowdworkers | the crowdsourcing tasks |
| Crowdworker-1 | Yes |
| Crowdworker-2 | Yes |
| Crowdworker-3 | No |

It can be observed from Table 3 that crowdworker-1 and crowdworker-2 allows the presentation of the advertisements along with the crowdsourcing tasks, whereas the crowdworker-3 does not allow the presentation of the advertisements. With the similar reasoning, as discussed in the previous step (i.e., step 304), the motivation for the crowdworkers to allow the presentation of the advertisements may be to earn extra income. For example, if a crowdworker gets 1 cent of reward for performing a crowdsourcing task, he/she may get an additional reward of 0.1 cent if he/she allows the presentation of the advertisements.

In an embodiment, the crowdworker may be asked to allow/authorize the presentation of the advertisements each time the crowdworker logs in into the crowdsourcing platform server 106. If the crowdworker allows the presentation of the advertisements, he/she may be presented with advertisements for the subsequent session with the crowdsourcing platform server 106. It will be apparent to a person skilled in the art that the configuration of the query to the crowdworker for determining his/her willingness to allow the presentation of the advertisements may be implemented in a manner suitable to the requirements from the requester/crowdsourcing platform server 106. For example, the crowdworkers may also be asked for the allowance of the presentation of the advertisements before presenting each crowdsourcing task, without limiting the scope of the disclosure.

If the processor 202 determines that the crowdworker allows the presentation of the advertisements along with the crowdsourcing tasks, step 308 is performed, else step 312 is performed.

At step 308, the one or more advertisements are presented to the crowdworker. In an embodiment, the processor 202 may present the one or more advertisements to the crowdworker along with the crowdsourcing tasks. In an embodiment, to determine the advertisements that can be displayed to the crowdworker, the processor 202 may utilize at least the profile information of the crowdworkers, the type of task being attempted by the crowdworkers, the profile information of the requesters, and the tasks that were previously performed by the crowdworkers. As discussed, the profile information may include various types of information associated with the crowdworkers and the requesters. Thus, the processor 202 may utilize such profile information to determine which advertisement should be presented to the crowdworker. For example, if the profile information corresponding to a crowdworker indicates that the crowdworker is from New York and is an avid Football fan (i.e. location and interest information), the processor 202 may display advertisement of the Buffalo Bulls Football team to that crowdworker. In a similar way, other types of information included in the profile information (e.g., gender information, and age information) may be utilized to determine the one or more advertisements that can be displayed to the crowdworker.

In an embodiment, the processor 202 may utilize the type of the tasks being attempted by the crowdworker to determine the advertisements to be displayed to the crowdworker. For example, if the processor 202 determines that the crowdsourcing task being attempted by the crowdworker corresponds to writing a summary for a detailed description, the processor 202 may display the advertisements related to writing courses to that crowdworker. In a similar way, if the crowdsourcing tasks being attempted by the crowdworker is related to targeted photography, the crowdworker may be presented with the advertisements related to photography.

In an embodiment, the processor 202 may utilize the information pertaining to the crowdsourcing tasks previously attempted by that crowdworker, to determine the one or more advertisements. For example, if the processor 202 determines that previously the crowdworker has attempted numerous tasks related to language translation, then it might be inferred that the crowdworker is interested in language related topics and, thus, may be presented with the advertisements related to language courses offered by various institutions.

It will be apparent to a person skilled in the art that various other types of information and combination thereof may be utilized by the processor 202 to determine the type of advertisements that should be displayed to the crowdworkers, without departing from the scope of the disclosure.

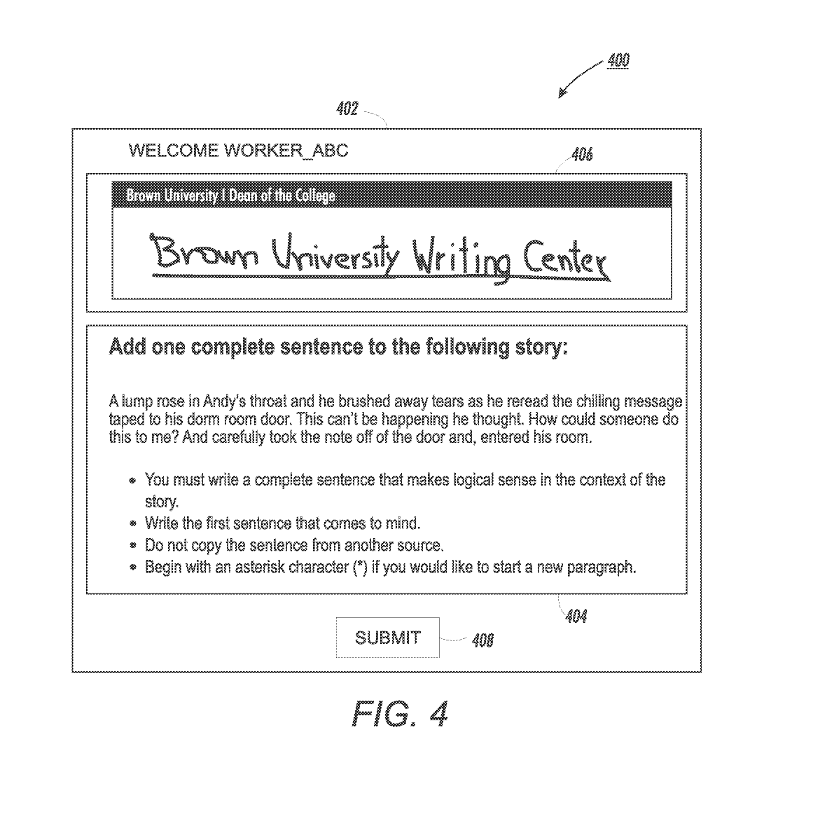

In an embodiment, the processor 202 may position the advertisements within the crowdsourcing tasks that are presented to the crowdworker. For example, the advertisements may be embedded within the one or more crowdsourcing tasks. In an embodiment, the advertisements may be presented in various other forms, such as, but not limited to, pop-up advertisements, voice advertisements, video advertisements, or any combination thereof. Further illustration of the presentation of the advertisements to the crowdworkers has been discussed in conjunction with FIG. 4. In an embodiment, the processor 202 may receive incentives from an advertiser based on the presentation of the advertisements to the crowdworker along with the task.

At step 310, an incentive is provided to the crowdworker. In an embodiment, the processor 202 may provide the incentives to the crowdworker, in addition to the remuneration for attempting the task. For example, if a requester pays 1 cent to a crowdworker for completing a crowdsourcing task, the crowdworker may receive an additional reward (i.e., incentive) of 0.1 cent for allowing the presentation of the advertisements. In an embodiment, the crowdworker may be rewarded with any of the monetary or non-monetary forms, as discussed above.

As discussed, if at step 304, it is determined that the requester does not allow the presentation of the one or more advertisements along with the one or more crowdsourcing tasks, then step 312 is performed. As discussed, the requester may not want to clutter the crowdsourcing tasks, presented to the crowdworker, with different types of advertisements, and in such scenarios, at step 312, the crowdworker may be presented with the crowdsourcing tasks without advertisements. The processor 202 may utilize various types of task distribution algorithms, known in the art, to distribute the crowdsourcing tasks to the crowdworkers.

In a similar way, if at step 306, it is determined that the crowdworker to whom the crowdsourcing tasks would be distributed, does not allow the presentation of the advertisements, the processor 202 may perform step 312.

At step 314, the remuneration is provided to the crowdworker. In an embodiment, the processor 202 may provide the remuneration to the crowdworker for completing the one or more crowdsourcing tasks. The crowdworker may be remunerated with any of the monetary, non-monetary, of a combination thereof, for completing the crowdsourcing tasks.

FIG. 4 illustrates a block diagram 400 for a crowdworker interface, in accordance with at least one embodiment. The block diagram 400 includes a display region 402 displayed to the crowdworker. The display region 402 includes a task 404, an advertisement 406, and a submit button 408, FIG. 4 has been described in conjunction with the FIG. 3.

In accordance with the step 302, the information pertaining to the crowdsourcing tasks and the advertisements is received. As discussed in conjunction with the step 302, the processor 202 may receive the information pertaining to the task 404 from the requester-computing device 104 and the information pertaining to the advertisement 406 from the advertisement server 110.

In accordance with the step 304, the processor 202 determines whether the requester allows the presentation of the advertisements along with the crowdsourcing tasks to the crowdworker. As discussed above, the processor 202 may determine this based on the information (refer Table 1) received from the requester. In an embodiment, the processor 202 determines that the requester allows the presentation of the advertisements along with the crowdsourcing task. In such scenarios, step 306 is performed.

In accordance with the step 306, the processor 202 determines whether the crowdworker allows the presentation of the advertisements along with the crowdsourcing tasks. As discussed in conjunction with the step 306, the processor may determine this based on the information (refer Table 3) received from the crowdworker. In an embodiment, the processor 202 determines that the crowdworker allows the presentation of the advertisements along with the crowdsourcing tasks. In such scenarios, step 308 is performed.

In accordance with the step 308, the one or more advertisements are presented to the crowdworker. As discussed in conjunction with the step 308, the processor 202 may display the one or more advertisements based on at least the profile information of the crowdworker, the profile information of the requester, the type of task 404 being attempted by the crowdworker, and the tasks that were previously performed by the crowdworker. For example, referring to the block diagram 400, the processor 202 may determine that since the task 404 corresponds to writing a summary of detailed information, the crowdworker might be interested in advertisement related to writing courses. Thus, the processor 202 may include the advertisement 406 (that corresponds to writing courses) along with the task 404, as displayed in the block diagram 400.

As discussed in conjunction with the FIG. 3, other types of information (e.g., profile information) may also be utilized by the processor 202 to determine the advertisement that should be displayed to the crowdworker along with the task 404.

In accordance with the step 310, an incentive is provided to the crowdworker. As discussed in conjunction with the step 310, the processor 202 may provide incentives to the crowdworker, in addition to the remuneration for attempting the task. The incentives are provided to the crowdworker for allowing the presentation of the advertisement 406 along with the task 404.

In accordance with the step 312, the crowdworker is presented with the task 404 without the advertisement 406. That is, if any one of the requester or the crowdworker does not allow the presentation of the advertisement, the crowdworker is presented only the task 404, without the advertisement 406 included in the display region 402. Further details about such scenarios have already been discussed in conjunction with FIG. 3.

In accordance with the step 314, the remuneration is provided to the crowdworker. As discussed in conjunction with the step 314, the processor 202 may provide the remuneration to the crowdworker for completing the task 404.

The disclosed embodiments encompass numerous advantages. Through various embodiments for methods and systems for displaying advertisements along with the crowdsourcing tasks, it is disclosed that the crowdworkers may earn extra income in addition to income earned through performing the crowdsourcing tasks. This kind of scenario may motivate the crowdworkers to allow the presentation of the advertisements, and to devote more time for performing the tasks through crowdsourcing. Further, the display of the advertisement may be controlled, by the crowdworkers, as per their convenience to perform the tasks presented to them. That is, the crowdworkers may opt-in or opt-out from the presentation of the advertisements.

Further, it is disclosed that the requesters may also opt-in for the presentation of the advertisement to the crowdworkers. In case, the requesters wishes to keep the crowdsourcing tasks free from advertisements (e.g., when the requesters do not want to distract the crowdworkers during performing the crowdsourcing tasks), they may do so by providing inputs to the crowdsourcing platform server. Whereas, if the requesters allow presenting the advertisements to the crowdworker, the requesters may receive discounts for posting the crowdsourcing tasks, as discussed above.

In addition, the crowdsourcing platform server may also earn profit by presenting the advertisements to the crowdworkers. For example, the crowdsourcing platform server may keep all or partial earnings from advertisers who are willing to post advertisements to promote their services/products. Thus, through various embodiments, it is disclosed that the crowdsourcing of the tasks may be made more cost effective for each of the crowdworkers, the requesters, and the platform server.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, Java, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for recommending crowdsourcing tasks have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for crowdsourcing a task, the method comprising:
presenting, by one or more processors, one or more advertisements to a worker along with said task, wherein said one or more advertisements are determined based on at least a type of said task being attempted by said worker, one or more tasks previously attempted by said worker, and a profile of said worker; and
providing, by said one or more processors, an incentive to said worker based on said presentation of said one or more advertisements, in addition to providing a remuneration for attempting said task.

2. The method of claim 1 further comprising receiving, by said one or more processors, an input from said worker, wherein said input is deterministic of an allowance to present said one or more advertisements along with said task.

3. The method of claim 2 further comprising receiving, by said one or more processors, a request from a requester to crowdsource said task, wherein said request includes at least an information pertaining to said allowance to present said one or more advertisements to said worker while said worker attempts said task.

4. The method of claim 3 further comprising offering, by said one or more processors, a discount to said requester on a price for crowdsourcing said task based on said allowance.

5. The method of claim 1, wherein said incentive comprises at least one of a coupon codes, discounts or offers within said one or more advertisements presented to said worker.

6. The method of claim 1, wherein said profile of said worker comprises at least one of a worker's location, gender, age, hobbies or search history.

7. The method of claim 1, wherein said task comprises at least one of an image/video/text labelling/tagging/categorization, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography, text/image analysis, directory compilation, or information search/retrieval.

8. The method of claim 1 further comprising receiving, by said one or more processors, said incentive from an advertiser based on said presentation of said one or more advertisements to said worker along with said task.

9. The method of claim 1, wherein said one or more advertisements are determined based on a profile of said requester.

10. The method of claim 9, wherein said profile of said requester comprises at least one of a requester's location, hobbies, or a type of said tasks posted by said requester.

11. A method for crowdsourcing a task, the method comprising:
receiving, by one or more processors, one or more advertisements and information pertaining to said task;
determining, by said one or more processors, an advertisement, from said one or more advertisements, for a worker based on at least a type of said task, one or more tasks previously attempted by said worker, and a profile of said worker; and
presenting, by said one or more processors, said task to said worker, wherein said advertisement is included in said task, and wherein said worker is incentivized for said advertisement, in addition to a remuneration for attempting said task.

12. A system for crowdsourcing a task, the system comprising:
one or more processors operable to:
present one or more advertisements to a worker along with said task, wherein said one or more advertisements are determined based on at least a type of said task being attempted by said worker, one or more tasks previously attempted by said worker, and a profile of said worker; and
provide an incentive to said worker based on said presentation of said one or more advertisements, in addition to providing a remuneration for attempting said task.

13. The system of claim 12, wherein said one or more processors are further operable to receive an input from said worker, wherein said input is deterministic of an allowance to present said one or more advertisements along with said task.

14. The system of claim 13, wherein said one or more processors are further operable to receive a request from a requester to crowdsource said task, wherein said request includes at least an information pertaining to said allowance to present said one or more advertisements to said worker while said worker attempts said task.

15. The system of claim 14, wherein said one or more processors are further operable to offer a discount to said requester on a price for crowdsourcing said task based on said allowance.

16. The system of claim 12, wherein said incentive comprises at least one of a coupon codes, discounts or offers within said one or more advertisements presented to said worker.

17. The system of claim 12, wherein said profile comprises at least one of a worker's location, gender, age, hobbies or search history.

18. The system of claim 12, wherein said task comprises at least one of an image/video/text labelling/tagging/categorization, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography, text/image analysis, directory compilation, or information search/retrieval.

19. The system of claim 12, wherein said one or more processors are further operable to receive said incentive from an advertiser based on said presentation of said one or more advertisements to said worker along with said task.

20. The system of claim 12, wherein said one or more advertisements are determined based on a profile of said requester.

21. The system of claim 20, wherein said profile of said requester comprises at least one of a requester's location, hobbies, or a type of said task posted by said requester.

22. A system for crowdsourcing a task, the system comprising:
one or more processors operable to:
receive one or more advertisements and information pertaining to said task;
determine an advertisement, from said one or more advertisements, for a worker based on at least a type of said task, one or more tasks previously attempted by said worker, and a profile of said worker; and
present said task to said worker, wherein said advertisement is included in said task, and wherein said worker is incentivized for said advertisement, in addition to a remuneration for attempting said task.

23. A computer program product for use with a computer, the computer program product comprising a non-transitory computer readable medium, wherein the non-transitory computer readable medium stores a computer program code for crowdsourcing one or more tasks, wherein the computer program code is executable by one or more processors to:
present one or more advertisements to a worker along with said task, wherein said one or more advertisements are determined based on at least a type of said task being attempted by said worker, one or more tasks previously attempted by said worker, and a profile of said worker; and
provide an incentive to said worker based on said presentation of said one or more advertisements, in addition to providing a remuneration for attempting said task.
